(19) United States
(12) Patent Application Publication
(10) Pub. No.: US 2016/0207013 A1
(43) Pub. Date: Jul. 21, 2016

(54) Device For Mixing Fluids

(71) Applicant: Turbulent Energy LLC, Buffalo, NY (US)

(72) Inventor: David Livshits, San Francisco, CA (US)

(21) Appl. No.: 14/988,778

(22) Filed: Jan. 6, 2016

(30) Foreign Application Priority Data
Jan. 15, 2015 (IL) 236719

(51) Int. Cl. B01F 5/06

(52) U.S. Cl. CPC B01F 5/0656

(57) ABSTRACT

A device is provided for mixing similar or dissimilar fluids into a homogenous fluids mix. The device operates without consuming additional energy.

### TECHNOLOGY FIELD

The present device is related to devices and apparatuses for mixing fluids.

### DEFINITIONS

As used in the present disclosure the term “fluid” includes liquids and gases.

As used in the present disclosure the term “swirl chamber” is a chamber where fluid introduced at an angle tangential to the chamber long axis generates a fluid swirling motion around the chamber long axis or along the walls of the chamber. The axis of rotation could be the axis of symmetry of the chamber.

As used in the present disclosure the term “deflector” is a device or a device component that changes the fluid flow parameters.

### BACKGROUND

In many industries and technical fields, like chemistry, biology, medicine, food manufacture, engine operation and others fluids have to be mixed, processed and brought to a condition that would ensure optimal operation of the device or process that consumes the mix. Often, preparation of a proper fluid mix requires a long sequence of different fluid processing steps. The fluid processing steps could be time consuming, limit the throughput and be prone to errors occurring during the procedure.

The known fluid mixing devices usually include moving parts that apply to the fluids certain force (pressure) to propel one or more fluids to a fluid mixing area or volume and consume certain amount of energy. Fluid mixing devices moving parts are prone to malfunctioning and as such require periodic maintenance. This complicates maintaining consistent concentration values in the fluid mix and size of particles in the fluid mix.

Specifically, the atomization of a solution into uniform particles by forming a contact between two different fluids can provide particles either too large or too small. The size of the particles could affect proper operation of a device using the atomized solution.

U.S. Pat. Nos. 8,715,378; 8,871,090; 8,746,965 and 8,844,495 to the same assignee and the same inventor disclose different methods of fluid mixing.

### SUMMARY

Described is a fluid mixing device which is operated and regulated automatically by the stream or flow of the fluids to be mixed. The fluid mixing device has no moving parts and is characterized by a high degree of reliability. The device transforms laminar fluid flow into a turbulent fluid flow of the fluids to be mixed and the turbulent flow mixes different fluid that could be similar or dissimilar fluids into a homogenous fluid mix.

Gaps between parts/components of the mixing device having a predetermined size allow for precise control of the proportions of fluids to be mixed and maintenance of a homogenous mix of the fluids and particles produced in the course of fluid mixing. Variation in gap size or gap with between the parts/components could be used to control the proportions of fluids to be mixed, size of the particles produced and resulting mix content.

The turbulent flow parameters, such as flow speed and pressure at different segments of the flow support, in addition to fluids mixing, the formation of fluid particles wherein one fluid envelopes or encapsulates the second fluid.

Overlapping physical effects resulting from adiabatic fluid expansion phenomena do not demand additional energy sources and, using essentially the same quantity of energy as traditional methods, air temperatures can be controlled and productivity and efficiency of the device can be increased.

### LIST OF FIGURES AND THEIR BRIEF DESCRIPTION

FIG. 1 is a three dimensional representation of a device for mixing fluids according to an example;

FIG. 2 is an example of a cross section of device for mixing fluids of FIG. 1;

FIG. 3 is an example of cross section of a swirl chamber of a device for mixing fluids of FIG. 1;

FIG. 4 is a cross section of a fluid deflector unit according to an example;

FIG. 5 is a cross section of liquid-gas mixing zone according to an example;

FIG. 6 is an example of a collector for mixing two fluids; and

FIG. 7 is an example of a collector for mixing more than two fluids.

### DESCRIPTION

As indicated above, the atomization of a solution into uniform particles by forming contact between two different fluids can provide particles either too large or too small. The size of the particles could affect proper operation of a device using the atomized solution.

This could be resolved by providing a fluid mixing device which is operated and regulated automatically by a stream or flow of the fluids to be mixed. The disclosed fluid mixing device has no moving parts and is characterized by a high degree of reliability. The device transforms laminar fluid flow into a turbulent fluid flow of the fluids to be mixed and the turbulent fluid flow mixes different fluids that could be similar or dissimilar in nature into a homogenous fluid mix.

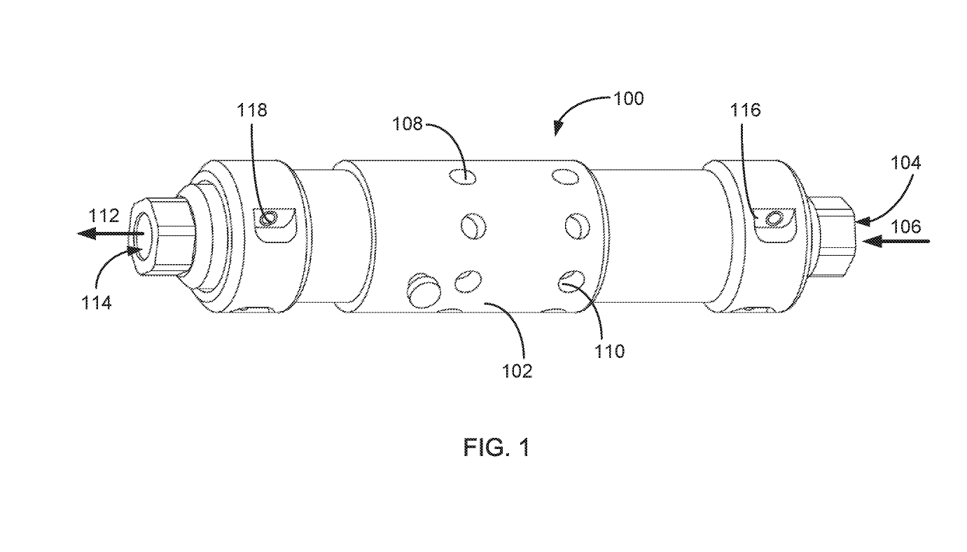

Referring now to FIG. 1 which is a three dimensional representation of a device for mixing fluids according to an example. Device 100 includes a tubular cylindrical housing or body 102 with a first inlet opening 104 configured to accept a first fluid, schematically shown by arrow 106, a number of lateral inlet openings 108 and 110 adapted to receive additional fluids (second, third and so on fluids) to be mixed with first fluid 106 or with additional fluids an outlet opening 114 through which the fluid mix 112 leaves device 100. Cutouts 116 include device 100 mounting holes 118. The first inlet opening 104 and outlet opening 114 are located at opposite ends of the housing 102 sharing a common longitudinal axis.

One or more pumps or compressors (not shown) could supply the first and the second and additional fluids to fluid mixing device 100. The fluids could be dissimilar fluids such as for example, water and gas, milk and gas, gasoline and gas or similar fluids such as water and gasoline, gasoline and ethanol, water and milk, insecticides and fertilizer into an irrigating spray, chlorine into a swimming pool and others. The fluids supplied to the device for fluid mixing 100 are thereby mixed or processed by device 100 and output from the outlet opening 114 located at a second end of the of tubular or cylindrical housing.

In some examples lateral inlet openings 108 and 110 can be arranged in series or arrays and share a common central longitudinal axis of the tubular or cylindrical housing 100.

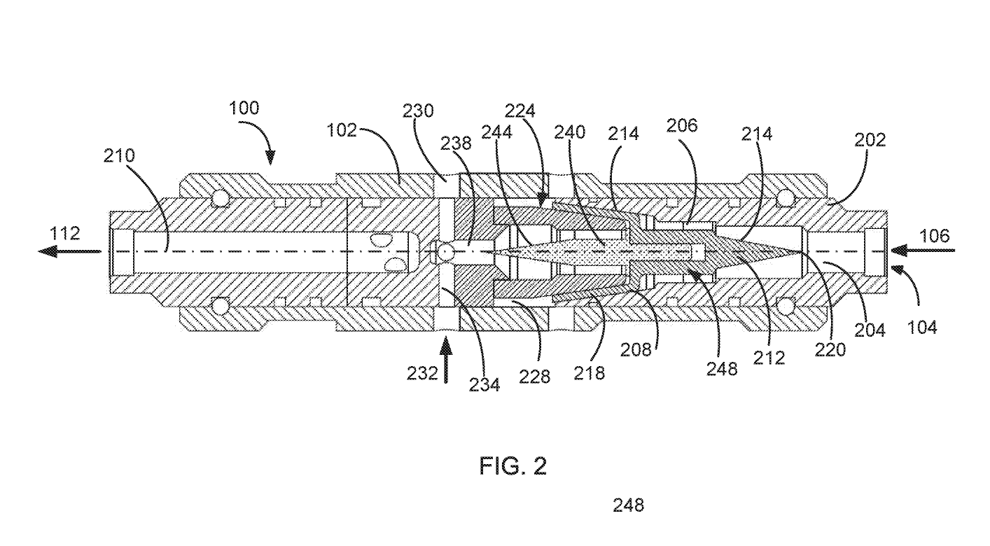

FIG. 2 is an example of a cross section of device for mixing fluids of FIG. 1. Device 100 includes a first housing or unit 202. First unit 202 houses a first fluid inlet 104 configured to receive the first fluid 106 and a first fluid conducting channel 204 having a segment 206 with a cylindrical shape and a segment 208 with a conical shape. Segment 206 and segment 208 have a common axis of symmetry 210. First fluid flow has a round cross section in cylindrical segment 206.

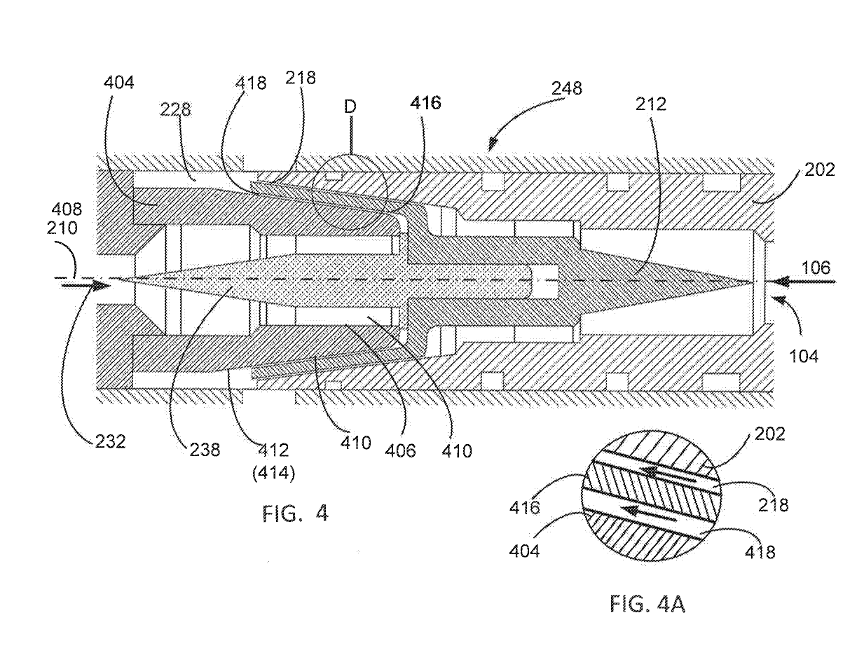

First housing or unit 202 accommodates an insert 212 with a conical external or outer surface 214 and an additional conical external or outer surface 214 corresponding to the housing 202 segment 208 with the inner conical shape cross section. When insert 212 is inserted into first housing or unit segment 208 with inner conical shape cross section the axes of symmetry of housing 202 and conical insert 212 coincide and segment 208 with inner conical cross section shape of first unit housing 202 and conical outer surface 214 of the insert form a conical gap 218 with a ring cross section, better illustrated in FIG. 4. The angle of the first conical deflector 212 could be 30 to 70 degrees. The width of the conical gap 218 with a ring cross section could be 1.0 to 200 micron. The conical gap 218 with ring cross section acts to increase the speed of the flow of the first fluid 106 and simultaneously increases the turbulence of the flow. The conical outer surface 214 of the insert 212 is operative to accept a first fluid 106 flow entering the device via the first fluid inlet 104 and to diverge the flow along the outer conical surface 214 into a mixing chamber 228.

In one example, conical outer surface 214 of insert 212 could be a smooth conical surface. In another example, surface 214 could include a plurality of groves distributed in regular or irregular intervals on the perimeter of conical insert 212. Each grove could have a length at least 10 times greater than its depth or diameter. In still a further example the groves could be made on inner surface of conical segment 208 of housing or unit 202.

Conical outer surface 214 of insert or deflector 212 is configured to receive the flow of the first fluid 106 having a cylindrical shape with a round cross section and volumetrically transform the first fluid flow from cylindrical to conical shape. Apex 220 and conical surface 214 of deflector 212 act to transform the first fluid flow 106 from a cylindrical shape with a round cross section into a conical flow with a ring cross section. Through the transformation of the flow of first fluid 106 from a cylindrical shape with a round cross section into a conical flow with a ring cross section, the first flow changes its parameters such as for example, speed, turbulence and pressure. Conical deflector 212 performs compression of incoming fluid and the transformation from a cylindrical fluid flow with round cross section into a conical flow with ring cross section. The area of the ring cross section is smaller than the area of the round cross section and the reduction in cross section area increases fluid flow turbulence.

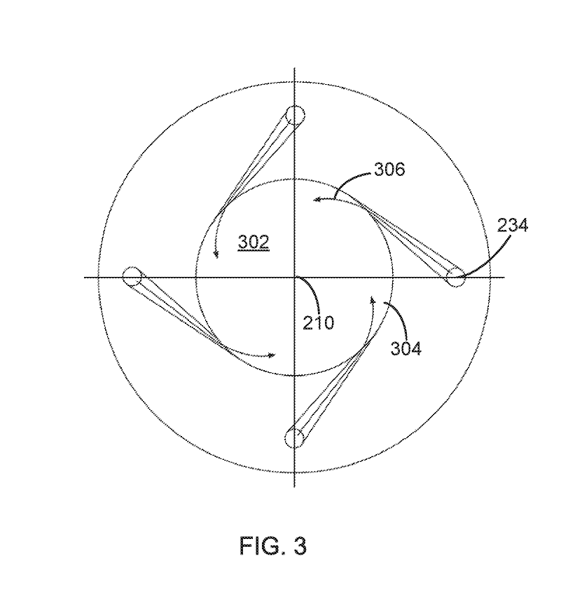

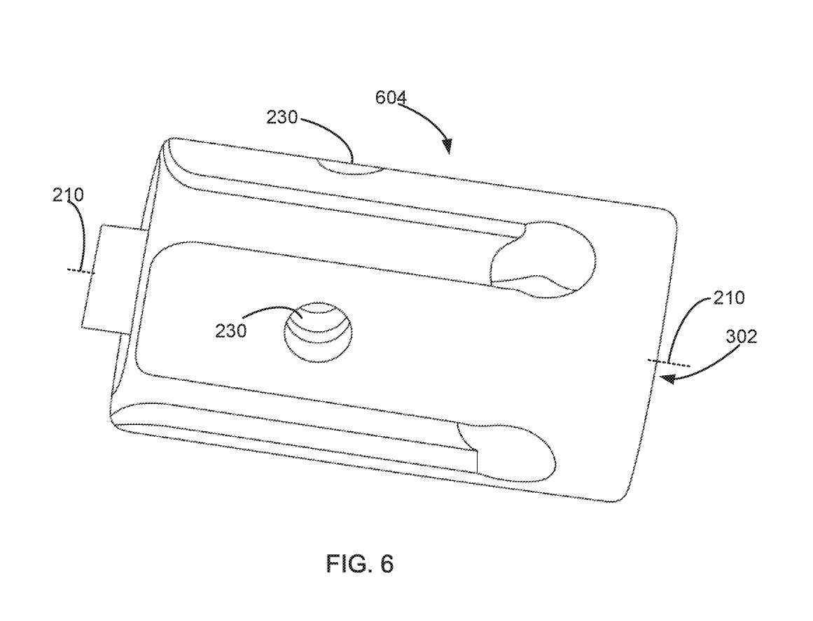

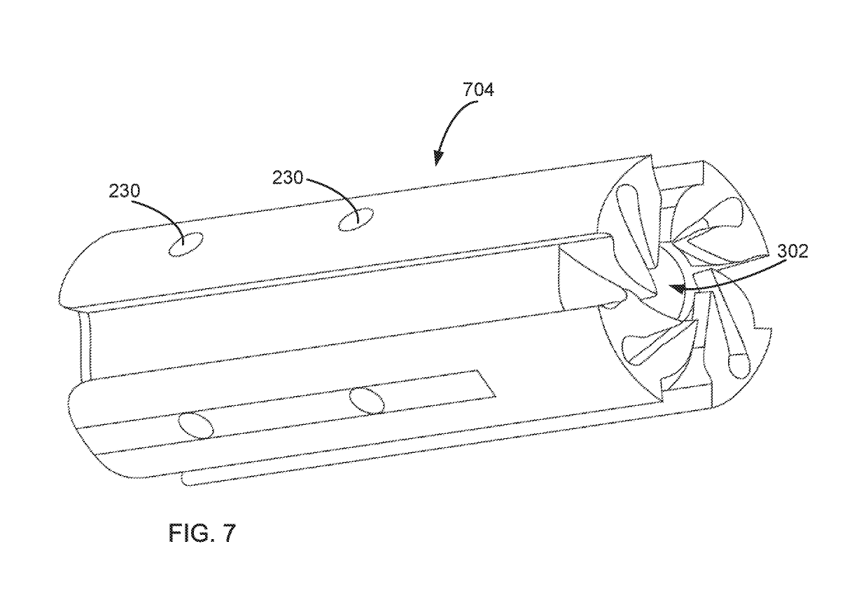

Device 100 further includes a second housing or unit 224. Second unit 224 houses a number of fluid inlets 230 configured to receive a second fluid flow shown by arrow 232. The second fluid could be a dissimilar fluid, for example a gas, or a similar fluid, for example a liquid. Second fluid inlets 230 are in fluid communication with second fluid input channels 234. Second fluid input channels 234 are oriented at an angle (FIG. 3) to the common axis of symmetry 210. Second housing or unit 224 also includes a collector with a swirl chamber 302 (FIG. 3) being in fluid communication with the second fluid input channel/s 234 and the second fluid conducting channel 238. Second unit or housing 224 has an axis of symmetry which is collinear (or coincides) with common axis 210 of first unit 202. As it will be explained later, the collector could be configured to accept one additional fluid (FIG. 6) or a plurality (two, three, . . . five) of additional fluids (FIG. 7).

Pressurized fluid is injected into a swirl chamber 302 of collector unit (604 or 704 FIGS. 6 and 7) through tangential channels 234 of the swirl chamber inner cavity that is used in a system of dynamic vortex mixing and activation. The swirl chamber 302 wall 304 represents a vortex generator contour that extends along axis 210 and plural tangential channels 234 extending tangentially inward from the axial cylindrical channel. The ends of tangential channels 234 open into the axial cylindrical chamber 302, and a vortex spiral 306 is formed within the axial cylindrical chamber around a stream of the first fluid. Vortex spiral 306 accelerates the fluid rotation rate. Although, according Ranque-Hilsch theorem, only the outer shell of the compressed fluid (closed to wall 304) is rotating.

An insert 240 with a conical outer surface 244 (FIG. 2) is inserted into second fluid 402 conducting channel 238. Insert 212 with a conical outer surface 214 and insert 240 with conical outer surface 244 form a fluid deflector unit 248. The angle of the second conical deflector 240 could be 30 to 70 degrees. Fluid deflector unit 248 is configured to change second fluid 402 flow parameters and includes at least (two) a first conical deflector surface 214 and a second conical deflector surface 244 with an axis of symmetry coaxial (or coinciding) with the common axis 210 of first unit 202 and apices 404 and 406 of conical deflectors 212 and 238 oriented in opposite directions. Deflector unit 240 is located between the first 202 and the second 224 units.

Fluid deflector unit 248 includes a bushing 404 (FIG. 4) with at least one segment 406 with an inner cylindrical shape and axis of symmetry 408 coaxial (or coinciding) with common axis of symmetry 210. Second conical deflector 238 is coupled to bushing 404 such that their axes of symmetry coincide (are coaxial) and the outer cylindrical segment of the second conical deflector 238 and the cylindrical segment 406 of bushing 404 form a cavity/gap 410 with a ring cross section. Bushing 404 includes an outer conical segment 412 with surface 414. The angle of the outer conical segment could be 15 to 60 degrees. Bushing 404 couples to the first conical deflector 212 such that their axes of symmetry coincide and outer conical segment 412 of the bushing 404 and the inner conical surface 416 of the first conical deflector 212 form a conical cavity/gap 418 with a ring cross section. The size of the channel/gap 418 could be 2.0 to 200 micron. The conical ring channel 418 acts to increase the speed of the flow of the second fluid and simultaneously increases the turbulence of the flow.

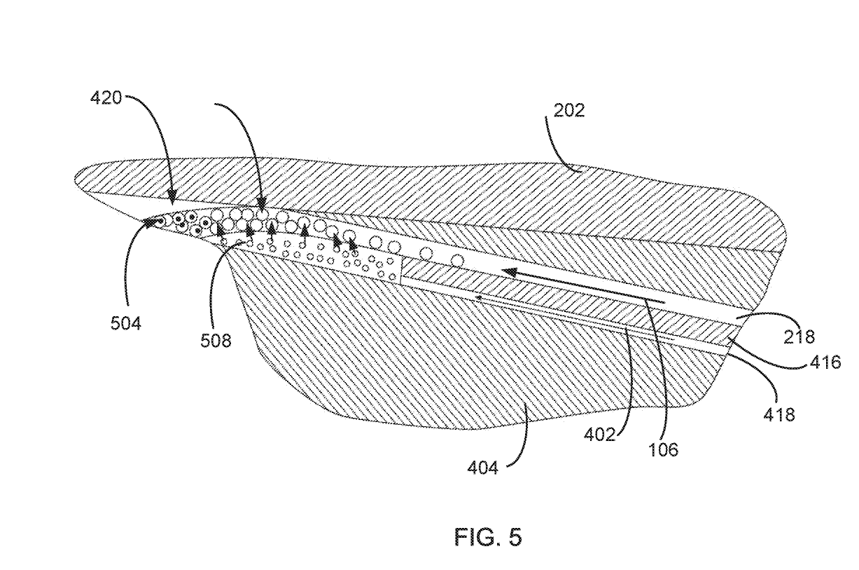

The flow of the first fluid 106 divided by first conical deflector 212 into a thin, ring cross section 218 flow or into separate streams with size of 50.0 to 150 micron enters the fluid mixing zone or chamber 228. Fluid pressure in the mixing zone 228 falls to a pressure lower than vapor pressure. The flow of the second fluid 232 in conical channel 418 with ring cross section changes direction in which the fluid flow moves and, owing to the high speed of the second fluid flow it also enters mixing zone 228. When the first fluid is a liquid and the second fluid is a gas, the gas is encapsulated into a liquid bubble 504 of the first fluid in the mixing zone 420, as illustrated in detail in FIG. 5. Liquid is incompressible and it cannot expand until it reaches the gas flow in the mixing zone 228 and enters in contact with gas 504. The gas flow 402 in contact with the liquid flow 106 collapses into a plurality gas bubbles 508. The liquid flow shown by arrow 106 and the gas flow 402 could be regulated by the width and orientation of the channels 218 and 418 with ring cross section and can create homogenous composite mixtures with ratios of 20 to less than 1, where the gas is encapsulated into the liquid. At the encapsulation stage, a double Bernoulli effect creates Joule-Thompson conditions and produces an internal vacuum in the mixing zone or chamber 420 forcing cavitation and quasi-boiling. The created liquid gas mixture 504 could be directed for different uses.

Depending on the ratios of gas to liquid, a foam-like mixture can be created and the mixture could be directed to outlet opening 114.

Variation in the size of ring ross section gaps or conical channels 218 and 418 could be used to control the proportions of fluids to be mixed, size of the particles produced and resulting mix content. Appropriate ratio of mixed fluids also could be regulated by the pressure of the delivered fluids, volume of the delivered fluids and type of the delivered fluids. For example, if one of the fluids is gas the compression ratio of the output flow could be increased as compared to a mix of two fluids. An electronic control system could be employed for control the pressure of the fluids, the volume of the fluids, and/or a ratio of the amount of the first fluid to the second or third fluid.

FIG. 6 is an example of a collector for mixing two fluids. Collector 604 includes second fluid inlets 230 that are in fluid communication with second fluid input channels 234 are oriented at an angle (FIG. 3) to the common axis of symmetry 210 and a swirl chamber schematically shown by arrow 302. Pressurized fluid injected into a swirl chamber 302 through tangential channels 234 is used in a system of dynamic vortex mixing and activation. Vortex spiral 306 accelerates the fluid rotation rate. Although, according Ranque-Hilsch theorem, only the outer shell of the compressed fluid (closed to wall 304) is rotating.

FIG. 7 is an example of a collector for mixing more than two fluids. Collector 704 includes a plurality of fluid inlets 230 and plurality of swirl chambers schematically shown by arrow 302. Principles of operation of collector 704 are similar to collector 604 operating principles.

Operation of device 100 (FIG. 1) does not require energy supply. Overlapping physical effects resulting from adiabatic fluid expansion (Joule-Thompson Effect) and from Ranque-Hilsch Effect phenomena do not demand additional energy sources and, using essentially the same quantity of energy as traditional methods, air temperatures can be lowered and productivity and efficiency of the device can be increased.

Apparatus or device described could be scaled to meet different throughput requirement and can also include multiple modules for producing additional fluid mixes pipeline.

What is claimed is:

1. An apparatus comprising
a first unit including:
a first fluid inlet configured to receive the first fluid and a first fluid conducting channel having a segment with a cylindrical shape and a segment with a conical shape and wherein both segments have a common axis of symmetry;
at least one second unit including:
at least one second fluid inlet configured to receive a second fluid and a fluid input channel oriented at an angle to the common axis of symmetry; and
a swirl chamber in communication with the second fluid input channel and a second fluid conducting channel with an axis collinear (coaxial) to the common axis of the first unit;
a fluid deflector unit configured to change fluid flow parameters and including at least (two) a first and a second conical deflectors with an axis collinear (coaxial) with the common axis of the first unit and apices oriented in opposite directions; and
wherein the deflector unit is located between the first and the second units.

2. The apparatus according to claim 1 wherein a first conical deflector outer surface corresponds to surface of an inner conical shape segment of the first unit and wherein the first conical deflector also includes an inner conical surface.

3. The apparatus according to claim 1 wherein first conical deflector is coupled to an inner conical shape segment of the first unit such that their axes of symmetry coincide and the inner conical shape of the segment of the first unit and the conical outer surface of the deflector unit form a conical channel/gap with a ring cross section.

4. The apparatus according to claim 1 wherein the segment with a conical shape of the first unit and the first conical deflector form a conical gap with a ring cross section and wherein the gap is 1 to 200 micron and wherein the angle of the first conical deflector is 30 to 70 degrees.

5. The apparatus according to claim 1 wherein the second unit comprises a bushing with at least one segment with an inner cylindrical shape and axis of symmetry collinear (coaxial) with the common axis of symmetry.

6. The apparatus according to claim 1 and wherein a second conical deflector is coupled to a bushing such that their axes of symmetry coincide and an outer cylindrical segment of the second conical deflector and the cylindrical segment of the bushing form a channel/gap with a ring cross section and wherein the bushing includes an outer conical surface and the bushing couples to the second conical deflector such that their axes of symmetry coincide and an outer conical segment of the bushing and an inner conical surface of a first conical deflector form a conical channel/gap with a ring cross section and wherein the gap is 1 to 200 micron.

7. The apparatus according to claim 1 wherein the swirl chamber is associated with an adiabatic expander configured to collect at least one fluid to be mixed and direct it to an outlet opening of the apparatus.

8. The apparatus according to claim 1 wherein the angle of a second conical deflector is 30 to 70 degrees.

9. The apparatus according to claim 1, wherein a gap between a first conical deflector outer surface and an inner conical shape segment of the first unit and a gap between outer conical surface of the bushing and the inner conical surface of the first conical deflector are variable width gaps and wherein the width of the gap depends on type of the fluids to be mixed.

10. The apparatus according to claim 1 wherein the apparatus is scalable and dimensions of the apparatus are selected according to throughput desired and number of fluids to be mixed.

11. An apparatus comprising;
a first housing including:
a part with a segment with an inner cylindrical shape segment and a segment with an inner conical shape and wherein both segments have a common axis of symmetry;
an insert with a conical outer surface corresponding to the housing segment with the inner conical shape segment and having an axis of symmetry; and
when the insert is inserted into a first housing segment with an inner conical shape such that their axes of symmetry coincide, the inner conical shape of the first housing segment and the conical outer surface of the insert form a conical channel/gap with a ring cross section;
a second housing including;
at least one second fluid inlet and a fluid input channel oriented at an angle to the common axis of symmetry;
a swirl chamber in communication with a second fluid input channel and a second fluid conducting channel with an axis collinear (coaxial) to the common axis of the first housing;
a bushing with at least one segment with an inner cylindrical shape and axis of symmetry collinear (coaxial) with the common axis of symmetry;
an insert with a conical outer surface segment and a cylindrical segment; and
when the insert is inserted into the bushing such that their axes of symmetry coincide the outer cylindrical segment of the insert and the cylindrical segment of the bushing form a channel/gap with a ring cross section; and
a collector communicating with the conical channel/gap with a ring cross section and the channel/gap with a ring cross section.

12. The apparatus according to claim 11 the second fluid inlet is tangential to the swirl chamber.

13. The apparatus according to claim 11 wherein the insert inserted in the first housing further comprises;
a cylindrical hole configured to receive a matching segment of a second insert with a conical outer surface;
an inner conical surface corresponding to the outer surface of the bushing;
a conical gap with circular cross section formed by the outer surface of the bushing and inner surface of insert inserted in the first housing.

14. The apparatus according to claim 11 wherein width the conical gap is variable and depends on type of fluids to be mixed.

15. The apparatus according to claim 11 further comprising a fluid output channel.

16. The apparatus according to claim 11 wherein the apparatus is scalable according to throughput desired and number of fluids to be mixed.

17. Apparatus comprising:
a cylindrical housing having a first fluid inlet at one end and a fluid outlet at a second end and at least one second fluid inlet in the housing wall and accommodating two or more components arranged in series and sharing a common central longitudinal axis, the components comprising:
at least one ring-shaped mixing chamber the outer wall of which defined by a portion of the cylindrical housing wall and being in communication with the fluid outlet;
at least one first conical deflector having an external surface and an internal surface and operative to accept a first fluid flow entering the apparatus via the first inlet and to diverge the flow along the external surface into the mixing chamber;
at least one collector having at least one channel in communication with the at least one second fluid inlet and operative to divert a second fluid flow entering the apparatus via the second fluid inlet in a direction coaxial with and opposite to the first fluid flow entering the apparatus;
at least one second conical deflector having at least an external surface and operative to accept the second fluid flow from the collector and to diverge the flow along the external surface thereof and onto the internal surface of the first conical deflector so that to mix with the first fluid flow in the mixing chamber.

18. The apparatus according to claim 17, wherein also comprising a cylindrical inlet component wherein at least a portion of the internal surface of the wall thereof is conically shaped so that to parallel the external surface of the first conical deflector and form a conical gap therebetween the gap being between 1 to 200 micron.
